(19) United States
(12) Patent Application Publication
(10) Pub. No.: US 2023/0362015 A1
(43) Pub. Date: Nov. 9, 2023

(54) NOTIFICATION CONTROL METHOD, VERIFICATION METHOD, AND INFORMATION PROCESSING APPARATUS

(71) Applicant: FUJITSU LIMITED, Kawasaki-shi (JP)

(72) Inventors: Keita KAYABA, Kawasaki (JP); Yuki YONEKURA, Kawasaki (JP); Yoshiki HIGASHIKADO, Yokohama (JP); Masanobu MORINAGA, Yokohama (JP); Yasushi TAKAHASHI, Kawasaki (JP); Rikuhiro KOJIMA, Kawasaki (JP)

(73) Assignee: FUJITSU LIMITED, Kawasaki-shi (JP)

(21) Appl. No.: 18/352,042

(22) Filed: Jul. 13, 2023

Related U.S. Application Data
(63) Continuation of application No. PCT/JP2021/013250, filed on Mar. 29, 2021.

(51) Int. Cl. H04L 9/32; H04L 9/00

(52) U.S. Cl. CPC H04L 9/3247; H04L 9/50; H04L 9/3239

(57) ABSTRACT

A storage unit stores transaction data to be recorded on a blockchain. When receiving identification information identifying a processing system for processing the transaction data among processing systems, a processing unit calculates a function value using a parameter corresponding to the received identification information and a function. The processing unit notifies a determination unit, which determines the processing system for processing the transaction data from among the processing systems, of the transaction data and signature data generated from the function value.

### CROSS-REFERENCE TO RELATED APPLICATION

This application is a continuation application of International Application PCT/JP2021/013250 filed on Mar. 29, 2021, which designated the U.S., the entire contents of which are incorporated herein by reference.

### FIELD

The embodiments discussed herein relate to a notification control method, a verification method, and an information processing apparatus.

### BACKGROUND

An information processing system may use a blockchain, which is a highly tamper-resistant distributed database. The information processing system records transaction data on the blockchain to facilitate proof of the authenticity of the transaction data. The blockchain is also referred to as a distributed ledger, and the transaction data is also referred to as transactions. The blockchain has a linked list structure in which a plurality of blocks each containing transaction data are connected.

There has been proposed a system that generates a block header including a timestamp, the hash value of the previous block, the hash value of the current block, and a digital signature, and appends a block including the block header and transactions to the end of a blockchain.

See, for example, U.S. Patent Application Publication No. 2019/0245698.

### SUMMARY

According to one aspect, there is provided a notification control method including: calculating, by a processor, upon receiving identification information identifying a processing system for processing transaction data to be recorded on a blockchain among a plurality of processing systems, a function value using a parameter corresponding to the received identification information and a function; and notifying, by the processor, a determination unit of the transaction data and signature data generated from the function value, the determination unit being configured to determine the processing system for processing the transaction data from among the plurality of processing systems.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for describing an information processing system according to a first embodiment;

FIG. 2 illustrates an example of an information processing system according to a second embodiment;

FIG. 3 is a block diagram illustrating an example of the hardware configuration of a server device;

FIG. 4 is a block diagram illustrating an example of the functions of server devices;

FIG. 5 illustrates an example of the data structure of transactions;

FIG. 6 illustrates an example of inconsistency in a blockchain;

FIG. 7 illustrates an example of signature generation using a hash chain;

FIG. 8 is a sequence diagram illustrating an example flow of signature generation and signature verification;

FIG. 9 is a flowchart illustrating a first example of a transaction issuance procedure;

FIG. 10 is a flowchart illustrating a first example of a transaction detection procedure;

FIG. 11 illustrates an example of signature generation using string concatenation;

FIG. 12 is a flowchart illustrating a second example of the transaction issuance procedure; and

FIG. 13 is a flowchart illustrating a second example of the transaction detection procedure.

### DESCRIPTION OF EMBODIMENTS

The transaction data recorded on a blockchain is highly reliable. Therefore, using the transaction data in the blockchain as input data, an information processing system may initiate another information processing that needs collaboration with another processing system. Applications that use the transaction data in the blockchain may be referred to as blockchain applications.

There may be a case where an application determines, from a plurality of candidate processing systems, a processing system to collaborate with for each transaction data. However, the transaction data recorded on the blockchain may have a format that is not compatible with this application, and therefore lack information for determining the processing system. If the format for transaction data is modified at a later time to add a new item, it may lead to format inconsistency among transaction data of the same type within the blockchain.

Hereinafter, embodiments will be described with reference to the accompanying drawings.

### First Embodiment

A first embodiment will be described.

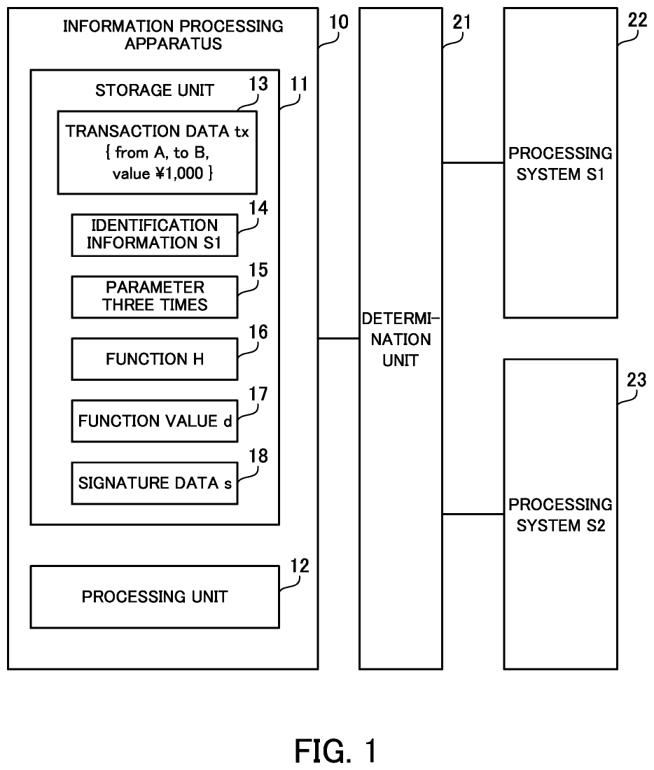

FIG. 1 is a view for describing an information processing system according to the first embodiment.

The information processing system of the first embodiment uses transaction data to be recorded on a blockchain to perform another information processing. The information processing apparatus 10 notifies a determination unit 21 of the transaction data to be recorded on the blockchain. The determination unit 21 determines, from among a plurality of processing systems including processing systems 22 and 23, a processing system for processing the transaction data in question.

The information processing apparatus 10 may be a client device or a server device. Alternatively, the information processing apparatus 10 may be a database server that stores the blockchain. The determination unit 21 may be provided in the information processing apparatus 10, or alternatively may be provided in an information processing apparatus different from the information processing apparatus 10. The determination unit 21 may be implemented by using application software and a processor. The determination unit 21 may send the transaction data to the processing system 22 or the processing system 23. The information processing apparatus 10 and the determination unit 21 may communicate with each other over a network, and the determination unit 21 and each processing system 22 and 23 may communicate with each other over a network.

Each of the processing systems 22 and 23 may include a server device. The processing systems 22 and 23 may perform the same type of information processing. The processing systems 22 and 23 may be blockchain systems that store different blockchains. For example, the information processing apparatus 10 belongs to a blockchain system that manages transfer of assets such as securities. For example, the processing systems 22 and 23 are payment systems that perform the payment of consideration for transactions. Information for use in determining a processing system is communicated from the information processing apparatus 10 to the determination unit 21. However, the transaction data does not include any independent item for the information.

The information processing apparatus 10 includes a storage unit 11 and a processing unit 12. The storage unit 11 may be a volatile semiconductor memory, such as a random access memory (RAM), or alternatively may be a non-volatile storage device, such as a hard disk drive (HDD) or a flash memory. For example, the processing unit 12 is a processor such as a central processing unit (CPU), a graphics processing unit (GPU), or a digital signal processor (DSP). The processing unit 12 may include an application specific integrated circuit (ASIC), a field programmable gate array (FPGA), or another application specific electronic circuit. The processor executes programs stored in a memory such as a RAM. A set of processors may be called a multiprocessor, or simply “a processor.”

The storage unit 11 stores transaction data 13. The transaction data 13 is transaction data that is to be recorded on a blockchain. The generation of signature data 18, which will be described later, is performed before the transaction data 13 is recorded on the blockchain, for example. Notification to the determination unit 21, which will be described later, may be performed before, or alternatively after, the transaction data 13 is recorded on the blockchain. The transaction data 13 includes items such as an assignor identifier, an assignee identifier, an asset identifier, and an amount. The format for the transaction data 13 may be defined in a program called a smart contract.

The processing unit 12 adds the signature data 18 to the transaction data 13. By doing so, the processing unit 12 is able to prove that the transaction data 13 has not been tampered with. For example, the signature data 18 is recorded together with the transaction data 13 on the blockchain.

At this time, the processing unit 12 receives identification information 14 identifying a processing system for processing the transaction data 13 among the plurality of processing systems. The processing system that is to process the transaction data 13 may be specified by a transaction party indicated in the transaction data 13. For example, the assignor or assignee of the assets may specify the processing system 22 as a payment system. Referring to the example of FIG. 1, the identification information 14 is the identification information of the processing system 22.

Then, the processing unit 12 calculates a function value 17 using a parameter 15 corresponding to the received identification information 14 and a function 16. The processing unit 12 then generates the signature data 18 from the function value 17. For example, the function 16 converts the transaction data 13 to the function value 17. The function 16 may be a hash function, and the function value 17 may be a hash value of the transaction data 13. However, the usage of the function 16 depends on the parameter 15. The signature data 18 is a digital signature generated from the function value 17 and a private key, for example.

The storage unit 11 may store a mapping table indicating the mapping between identification information and parameters. The mapping between identification information and parameters is a bijection, i.e., a one-to-one correspondence. The processing unit 12 may specify the parameter 15 corresponding to the identification information 14 with reference to the mapping table. The parameter 15 may indicate a string to be added to the transaction data 13. For example, the processing unit 12 may add the string indicated by the parameter 15 to the transaction data 13. The processing unit 12 may append the string to the end of the transaction data 13. The processing unit 12 feeds the transaction data 13 having the string added thereto, to the function 16 and uses the output of the function 16 as the function value 17.

Alternatively, the parameter 15 may indicate the number of transformation rounds regarding data transformation. For example, the processing unit 12 may calculate the function value 17 from the transaction data 13 by performing iterative data transformations on the transaction data 13. A data transformation may be a hash operation, and the iterative data transformations may be a so-called hash chain. A plurality of rounds of the data transformation may be executed, all by the function 16 or by different functions.

In this case, the processing unit 12 performs the data transformation for the number of transformation rounds indicated by the parameter 15. In the case where the number of transformation rounds is one, the processing unit 12 feeds the transaction data 13 to the function 16 and uses the output of the first round of the function 16 as the function value 17. In the case where the number of transformation rounds is two, for example, the processing unit 12 feeds the transaction data 13 to the function 16, then feeds an intermediate function value, which is the output of the first round of the function 16, to the function 16, and uses the output of the second round of the function 16 as the function value 17.

The processing unit 12 notifies the determination unit 21 of the transaction data 13 and signature data 18. The processing unit 12 may send the transaction data 13 and signature data 18 in response to a request from the determination unit 21. In addition, the processing unit 12 may retrieve the transaction data 13 and signature data 18 from the blockchain and send the transaction data 13 and signature data 18 to the determination unit 21. In this connection, the transaction data 13 supplied to the determination unit 21 does not include the identification information 14 itself.

The determination unit 21 receives the transaction data 13 and signature data 18. Upon the reception, the determination unit 21 verifies the signature data 18 to confirm that the transaction data 13 has not been tampered with. For example, the determination unit 21 decrypts the signature data 18 with the public key of the information processing apparatus 10, calculates a function value from the transaction data 13, and compares the decryption result with the function value. If they match, it means that the verification is successful. If they do not match, on the other hand, it means that the verification fails.

At this time, the determination unit 21 calculates the function value from the transaction data 13 in the same manner as the information processing apparatus 10. However, the determination unit 21 does not know the identification information 14 used by the information processing apparatus 10. Therefore, the determination unit 21 tries at least one of the plurality of pieces of identification information corresponding to the plurality of information processing systems. By doing so, the determination unit 21 specifies the identification information 14 used by the information processing apparatus 10, and specifies the designated processing system. The information processing apparatus 10 and the determination unit 21 may share the same mapping table.

For example, the determination unit 21 calculates a function value using the parameter corresponding to the identification information of the processing system 22 and the function 16 and verifies the signature data 18. If the verification is successful, the determination unit 21 determines that the processing system 22 is a processing system for processing the transaction data 13. Similarly, for example, the determination unit 21 calculates a function value using the parameter corresponding to the identification information of the processing system 23 and the function 16 and verifies the signature data 18. If the verification is successful, the determination unit 21 determines that the processing system 23 is a processing system for processing the transaction data 13.

As described above, the information processing apparatus 10 of the first embodiment receives the identification information 14 identifying a processing system for processing the transaction data 13, and calculates the function value 17 using the parameter 15 corresponding to the identification information 14 and the function 16. The information processing apparatus 10 notifies the determination unit 21 of the transaction data 13 and the signature data 18 generated from the function value 17. The determination unit 21 is able to specify the identification information 14 through the verification of the signature data 18.

In the manner described above, the identification information 14 is communicated from the information processing apparatus 10 to the determination unit 21. The identification information 14 itself does not need to be included in the transaction data 13. Therefore, even when the determination unit 21 needs to use the identification information of a processing system at a later time, there is no need to make any changes to the format for the transaction data 13, such as adding an item for the identification information to the transaction data 13. In addition, even when the number of candidate processing systems for processing the transaction data 13 increases, there is also no need to make any changes to the format. Furthermore, changes in the method of generating the signature data 18 do not affect the format for the signature data 18. Therefore, the consistency with existing transaction data already recorded on the blockchain is maintained.

### Second Embodiment

A second embodiment will now be described.

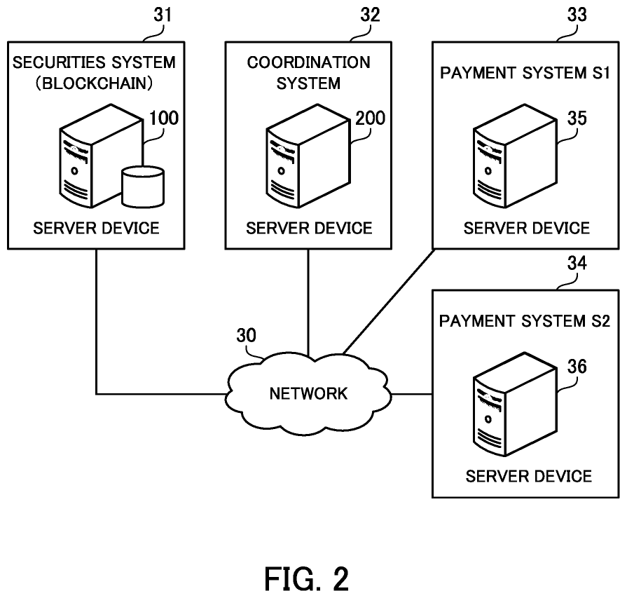

FIG. 2 illustrates an example of an information processing system according to the second embodiment.

The information processing system of the second embodiment may include a securities system 31, a coordination system 32, and payment systems 33 and 34, which are connected to a network 30. The network 30 may include a local area network (LAN), or alternatively may include the Internet.

The securities system 31 is an information processing system that records transactions indicating transfer of securities in a database. The securities system 31 uses a blockchain as the database. The securities system 31 includes a server device 100. The server device 100 is a server computer that stores the blockchain. The securities system 31 may include two or more server devices that store copies of the same blockchain.

The coordination system 32 is an information processing system that coordinates the securities system 31 and each of the payment systems 33 and 34. The coordination system 32 includes a server device 200. The server device 200 is a server computer that monitors the blockchain stored in the securities system 31. The server device 200 detects transactions satisfying specified conditions from the blockchain stored in the securities system 31. The transactions satisfying the specified conditions are transactions indicating sales contracts for transferring securities for consideration between different users.

When the server device 200 detects a transaction satisfying the specified conditions, the server device 200 selects one payment system on the basis of the detected transaction and requests the selected payment system to settle the consideration for the transfer. For example, the server device 200 sends to the selected payment system a message including a payer, a recipient, and a transfer amount. As a result, the consideration for the transfer is automatically settled using the payment system provided outside the securities system 31.

The server device 200 executes application software, which is triggered by the recording of a transaction on the blockchain. This application software may be referred to as a blockchain application (BC application). The monitoring function to detect a new transaction may be implemented in either the securities system 31 or the coordination system 32. Alternatively, without taking the securities system 31 and the coordination system 32 separately, the blockchain application may be executed by the securities system 31, or alternatively may be executed by the server device 100 that stores the blockchain.

The payment systems 33 and 34 are information processing systems that perform payments for sales contracts. The payment currency may be a legal tender circulating in a specific region, such as the dollars or yen, or alternatively may be a cryptocurrency. In response to requests from the coordination system 32, the payment systems 33 and 34 transfer currency amounts between accounts of different users. For example, the payment system 33 performs payments in legal tender, whereas the payment system 34 performs payments in cryptocurrency. The payment system 33 includes a server device 35, whereas the payment system 34 includes a server device 36. The server devices 35 and 36 are server computers that perform the payments.

Each payment system 33 and 34 may also be a blockchain system that records the transfer of currency amounts on a blockchain. For example, the payment systems 33 and 34 may record transactions each indicating a payer, a recipient, and a transfer amount. In this case, the coordination system 32 corresponds to a blockchain coordination system that connects a plurality of blockchain systems. The server devices 35 and 36 may store the blockchains. In addition, the payment systems 33 and 34 each may include two or more server devices that store copies of the same blockchain.

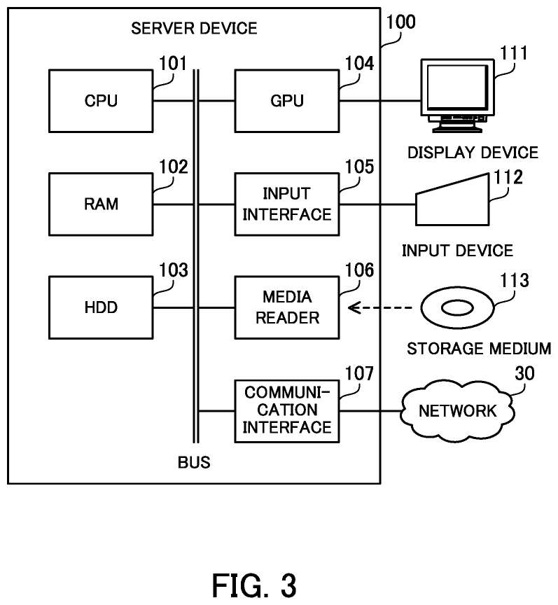

FIG. 3 is a block diagram illustrating an example of the hardware configuration of a server device.

The server device 100 includes a CPU 101, a RAM 102, an HDD 103, a GPU 104, an input interface 105, a media reader 106, and a communication interface 107, which are connected to a bus. The CPU 101 corresponds to the processing unit 12 of the first embodiment. The RAM 102 or HDD 103 corresponds to the storage unit 11 of the first embodiment. The server devices 35, 36, and 200 may have the same hardware configuration with the server device 100.

The CPU 101 is a processor that executes program commands. The CPU 101 loads at least part of a program and data from the HDD 103 to the RAM 102 and executes the program. The server device 100 may be provided with a plurality of processors. A set of processors may be called a multiprocessor, or simply “a processor.”

The RAM 102 is a volatile semiconductor memory that temporarily stores programs that are executed by the CPU 101 and data that is used by the CPU 101 in processing. The server device 100 may be provided with a different kind of volatile memory than RAM.

The HDD 103 is a non-volatile storage device that stores software programs such as operating system (OS), middleware, and application software, and data. The server device 100 may be provided with a different kind of non-volatile storage device such as a flash memory or a solid state drive (SSD).

The GPU 104 generates images in conjunction with the CPU 101, and outputs the images to a display device 111 connected to the server device 100. For example, the display device 111 is a cathode ray tube (CRT) display, a liquid crystal display, an organic electro-luminescence (EL) display, or a projector. Another type of output device such as a printer may be connected to the server device 100.

The input interface 105 receives input signals from an input device 112 connected to the server device 100. For example, the input device 112 is a mouse, a touch panel, or a keyboard. A plurality of types of input devices may be connected to the server device 100.

The media reader 106 is a reading device that reads programs and data from a storage medium 113. For example, the storage medium 113 is a magnetic disk, an optical disc, or a semiconductor memory. Magnetic disks include flexible disks (FDs) and HDDs. Optical discs include compact discs (CDs) and digital versatile discs (DVDs). The media reader 106 copies a program and data read from the storage medium 113 to another storage medium such as the RAM 102 or HDD 103. The read program may be executed by the CPU 101.

The storage medium 113 may be a portable storage medium. The storage medium 113 may be used for distribution of programs and data. In addition, the storage medium 113 and HDD 103 may be called computer-readable storage media.

The communication interface 107 is connected to the network 30, and communicates with other server devices over the network 30. The communication interface 107 may be a wired communication interface that is connected to a wired communication device such as a switch or a router, or alternatively may be a wireless communication interface that is connected to a wireless communication device such as a base station or an access point.

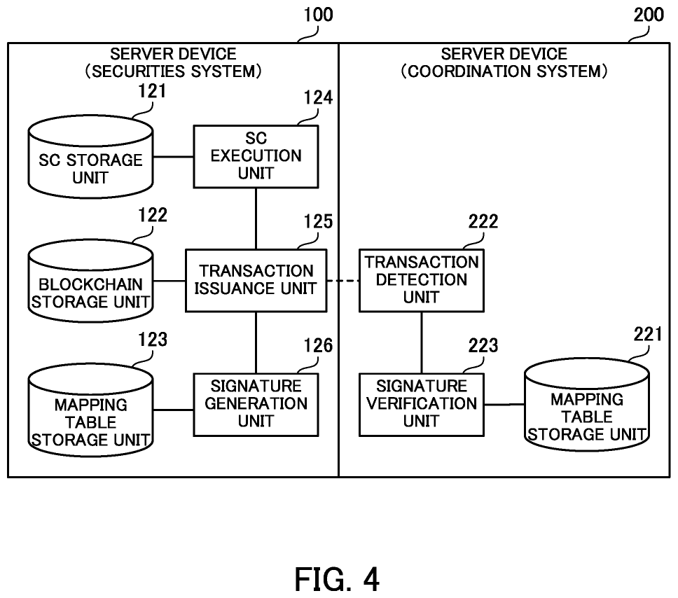

FIG. 4 is a block diagram illustrating an example of the functions of server devices.

The server device 100 includes a smart contract (SC) storage unit 121, a blockchain storage unit 122, a mapping table storage unit 123, an SC execution unit 124, a transaction issuance unit 125, and a signature generation unit 126. The SC storage unit 121, blockchain storage unit 122, and mapping table storage unit 123 are implemented by using the RAM 102 or HDD 103, for example. The SC execution unit 124, transaction issuance unit 125, and signature generation unit 126 are implemented by using the CPU 101 and programs, for example.

The SC storage unit 121 stores a smart contract. The smart contract is an application program that automates the execution of contracts. The smart contract is created by an administrator who defines a contract type, and is registered in the server device 100. The smart contract defines input data for the execution of contracts, and a format for transactions that are to be recorded on a blockchain when the contracts are concluded. The smart contract is identified by a smart contract ID (SCID). Since the server device 100 belongs to the securities system 31, the smart contract stored in the SC storage unit 121 is designed to automatically execute sales contracts for securities.

The blockchain storage unit 122 stores a blockchain. The blockchain has a linked list structure in which a plurality of blocks are connected. Each block contains a specified number of transactions and the hash value of the previous block. A new transaction is added to the last block of the blockchain.

The mapping table storage unit 123 stores a mapping table that is used in generating a signature to be added to a transaction. The signature and mapping table will be described later.

The SC execution unit 124 executes a smart contract. When receiving a smart contract ID and input data from the transaction issuance unit 125, the SC execution unit 124 retrieves the designated smart contract from the SC storage unit 121 and feeds the input data to the smart contract. The SC execution unit 124 outputs a transaction generated by the smart contract to the transaction issuance unit 125.

The transaction issuance unit 125 records a transaction on the blockchain. The transaction may be generated either by a smart contract or directly based on user input. In the former case, the transaction issuance unit 125 outputs a smart contract ID and input data received from a user to the SC execution unit 124 and obtains a transaction from the SC execution unit 124. In the latter case, the transaction issuance unit 125 generates a transaction that includes the input data received from the user.

Before recording the transaction on the blockchain, the transaction issuance unit 125 outputs the transaction to the signature generation unit 126 and obtains a signature from the signature generation unit 126. As will be described later, the transaction issuance unit 125 may also output accompanying information, which is provided by the user but is not included in the transaction, together with the transaction to the signature generation unit 126. The transaction issuance unit 125 adds the signature to the transaction, and records the signed transaction on the blockchain.

In addition, in response to a request from the coordination system 32, the transaction issuance unit 125 retrieves a new transaction from the blockchain and sends the transaction to the coordination system 32.

The signature generation unit 126 generates a signature that is to be added to a transaction. When receiving the transaction from the transaction issuance unit 125, the signature generation unit 126 generates a digest from the transaction and then generates a digital signature with the digest and the private key of the securities system 31. As will be described later, the signature generation unit 126 may change the signature generation method on the basis of the accompanying information received from the transaction issuance unit 125 and the mapping table stored in the mapping table storage unit 123.

The server device 200 includes a mapping table storage unit 221, a transaction detection unit 222, and a signature verification unit 223. The mapping table storage unit 221 is implemented by using a RAM or HDD provided in the server device 200, for example. The transaction detection unit 222 and signature verification unit 223 are implemented by using a CPU and programs provided in the server device 200, for example.

The mapping table storage unit 221 stores the same mapping table as that stored in the server device 100. The mapping tables stored in the server devices 100 and 200 may be periodically synchronized with each other.

The transaction detection unit 222 corresponds to a blockchain application that uses transactions recorded on the blockchain. The transaction detection unit 222 obtains transactions newly recorded on the blockchain from the securities system 31 and detects a new transaction satisfying specified conditions. The detected new transaction includes a signature. The transaction detection unit 222 outputs the transaction to the signature verification unit 223 and obtains the verification result of the signature from the signature verification unit 223.

If the signature verification is successful, the transaction detection unit 222 extracts information used for payment from the transaction, generates a payment request message, and sends the payment request message to one payment system. The payment system to be used here may be fixed in advance. In this connection, as will be described later, the transaction detection unit 222 may select a payment system on the basis of accompanying information that is obtained from the signature verification unit 223. On the other hand, if the signature verification has failed, the transaction detection unit 222 outputs an error message indicating payment rejection. The transaction detection unit 222 may send the error message to the securities system 31.

The signature verification unit 223 verifies the signature included in a transaction to confirm that the transaction has not been tampered with. When receiving the transaction from the transaction detection unit 222, the signature verification unit 223 generates a digest from part of the transaction other than the signature, decrypts the signature with the public key of the securities system 31, and compares the generated digest with the decryption result. If they match, the signature verification unit 223 determines that the verification is successful. If they do not match, on the other hand, the signature verification unit 223 determines that the verification fails. The signature verification unit 223 then notifies the transaction detection unit 222 of the success or failure of the signature verification.

As will be described later, in the course of the process of verifying the signature included in the transaction, the signature verification unit 223 may generate accompanying information that is not included in the transaction, with reference to the mapping table stored in the mapping table storage unit 221. In this case, the signature verification unit 223 outputs the generated accompanying information to the transaction detection unit 222.

The following describes extension of information that is contained in a transaction.

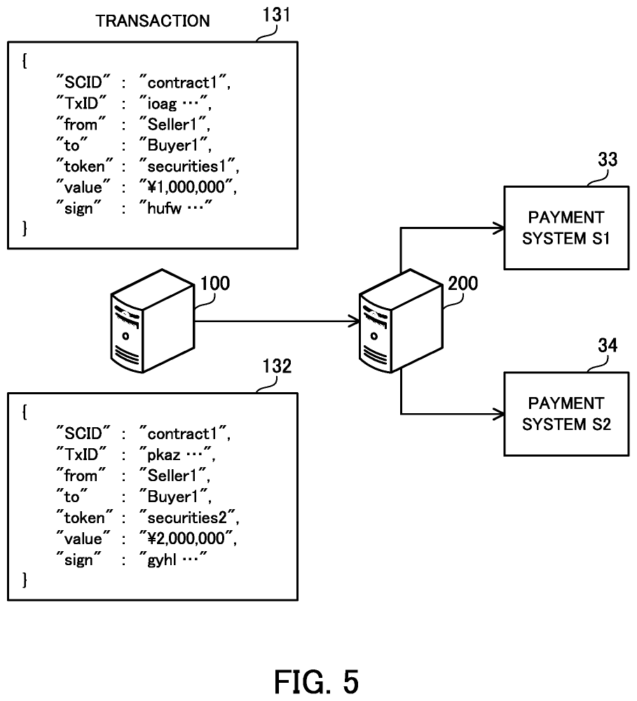

FIG. 5 illustrates an example of the data structure of transactions.

Transactions 131 and 132 are examples of transactions to be recorded on a blockchain. Each transaction 131 and 132 includes a smart contract ID, a transaction ID, an assignor ID, an assignee ID, a token, a value, and a signature.

The smart contract ID is an identifier identifying a smart contract having executed a contract. The transaction ID is an identifier identifying a transaction. The assignor ID is an identifier identifying a user who is the assignor of assets. The assignee ID is an identifier identifying a user who is the assignee of the assets. The token is an identifier identifying the assets transferred. The value indicates a currency amount of the consideration for the assets transferred. The signature is a digital signature calculated from the values of items included in the transaction other than the signature.

The server device 100 generates the transactions 131 and 132 and records them on the blockchain. The server device 200 detects the transactions 131 and 132 that need payment processing from the blockchain. Assume now that the server device 200 uses only the payment system 33. In this case, the server device 200 requests the payment system 33 to perform payments for both the transactions 131 and 132.

Consider now the case where the server device 200 adds the payment system 34 as an available payment system. In this case, the contracting parties are allowed to select either the payment system 33 or the payment system 34 for each transaction. For example, for the payment processing, the contracting parties may desire to use the payment system 33 for the transaction 131 and the payment system 34 for the transaction 132.

However, since the existing smart contract is not designed to allow for the selection of a payment system, the transactions 131 and 132 do not include an item to specify a payment system. This means that the transactions 131 and 132 lack information needed for the server device 200 to select the payment system. That is, because of the addition or functional extension of a blockchain application, transactions may lack information that the coordination system 32 needs.

One possible solution to the lack of information is to modify the smart contract so as to change the transaction format. In this case, the addition of an item to specify a payment system to each transaction 131 and 132 may be considered. However, to change the transaction format at a later time may be problematic, as will be explained below.

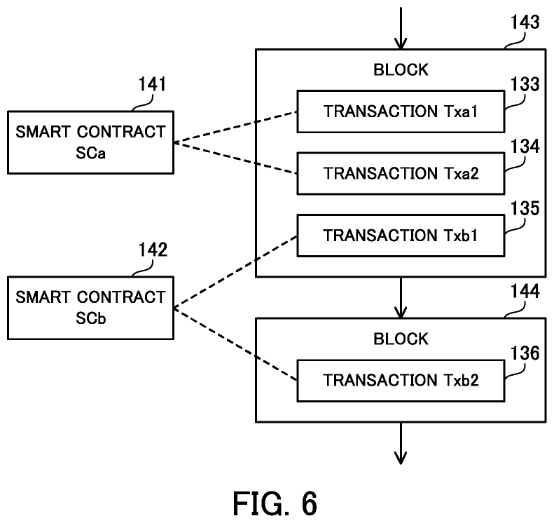

FIG. 6 illustrates an example of inconsistency in a blockchain.

Blocks 143 and 144 are included in a blockchain. The block 144 immediately follows the block 143. The block 143 includes transactions 133, 134, and 135, whereas the block 144 includes a transaction 136.

The transactions 133 and 134 are generated by a smart contract 141. Therefore, the transactions 133 and 134 each include the smart contract ID of the smart contract 141 and are linked to the smart contract 141. The transactions 135 and 136 are generated by a smart contract 142. Therefore, the transactions 135 and 136 each include the smart contract ID of the smart contract 142 and are linked to the smart contract 142.

The smart contract 142 is equivalent to a modification of the smart contract 141 that includes an additional item to specify a payment system in a transaction. Some blockchain systems do not allow modifications to smart contracts once registered, in view of security and data reliability. In order to change the transaction format, the smart contract 142 needs to be registered as a new smart contract separately from the smart contract 141.

However, since a new smart contract ID is generated accordingly, the transactions 133 and 134 in the old format are not linked to the smart contract 142. Therefore, it becomes difficult to manage the transactions 133 and 134 in the old format and the transactions 135 and 136 in the new format uniformly, which leads to a consistency problem within the blockchain. In addition, the number of transactions generated by the same smart contract is used as an indicator for the reliability of the smart contract. Therefore, the creator of the smart contract may prefer not to modify the existing smart contract.

To deal with this, instead of adding any new item to transactions, the second embodiment is designed such that the securities system 31 communicates accompanying information to the coordination system 32. The signature included in a transaction is used for communicating the accompanying information. The use of the signature for communicating the accompanying information does not cause any changes in the format of the signature, including the data length of the signature.

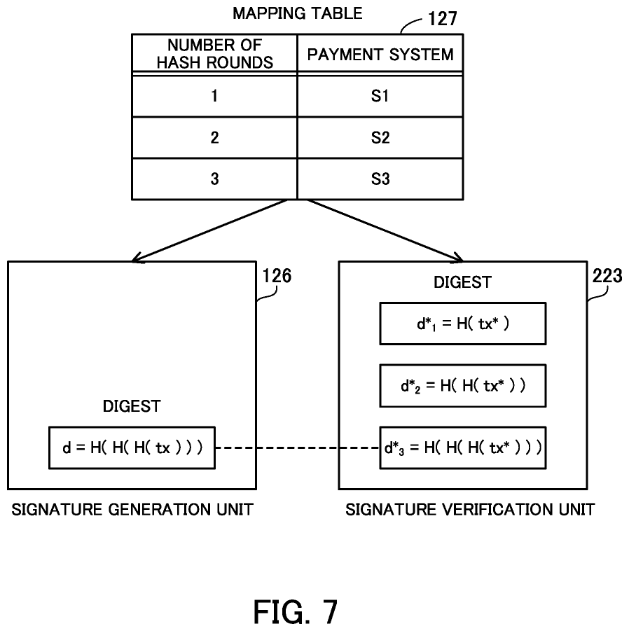

FIG. 7 illustrates an example of signature generation using a hash chain.

The transaction issuance unit 125 receives, from a user, information specifying a payment system in addition to input data for the execution of a contract. The transaction issuance unit 125 generates a transaction without a signature, and then notifies the signature generation unit 126 of the identifier of the designated payment system as well as the generated transaction. The signature generation unit 126 generates a signature that is dependent on the received payment system identifier.

In the second embodiment, the mapping table storage units 123 and 221 store a mapping table 127. The mapping table 127 associates the number of hash rounds with a payment system. The number of hash rounds is a key, whereas the payment system is a value. The mapping between the number of hash rounds and a payment system is a bijection, i.e., a one-to-one correspondence. For example, the number of hash rounds of “1” corresponds to a payment system identifier S1, the number of hash rounds of “2” corresponds to a payment system identifier S2, and the number of hash rounds of “3” corresponds to a payment system identifier S3.

The signature generation unit 126 generates a digest d from a transaction tx without a signature, using a variable-length hash chain. The hash chain involves iterative transformations that apply the same hash function H to input data one or more times in a row.

In the case where the number of hash rounds is one, the signature generation unit 126 feeds the transaction tx to the hash function H, and uses the output of the first round of the hash function H as the digest d. In the case where the number of hash rounds is two, the signature generation unit 126 feeds the output of the first round of the hash function H to the hash function H, and uses the output of the second round of the hash function H as the digest d. In the case where the number of hash rounds is three, the signature generation unit 126 feeds the output of the second round of the hash function H to the hash function H, and uses the output of the third round of the hash function H as the digest d.

The number of hash rounds, which represents the length of the hash chain, is determined with reference to the mapping table 127. The signature generation unit 126 searches the mapping table 127 for the number of hash rounds corresponding to the received payment system identifier. The signature generation unit 126 performs the hash operation for the found number of hash rounds to convert the transaction tx to the digest d.

The signature generation unit 126 generates a signature s using the digest d and a private key skey. The transaction issuance unit 125 adds the signature s to the transaction tx to thereby generate a signed transaction Tx. The transaction issuance unit 125 records the transaction Tx on the blockchain.

The transaction detection unit 222 detects a transaction Tx* satisfying specified conditions from the blockchain. Then, the transaction detection unit 222 separates the transaction Tx* into the transaction tx* without a signature and a signature s*. The signature verification unit 223 verifies the signature s* on the basis of the transaction tx* and the mapping table 127.

The signature verification unit 223 generates a digest d* from the transaction tx* in the same manner as the signature generation unit 126. In addition, the signature verification unit 223 decrypts the signature s* with a public key pkey. The signature verification unit 223 compares the decryption result with the digest d*. If they match, it means that the verification is successful. If they do not match, on the other hand, it means that the verification fails.

However, the signature verification unit 223 does not know the correct number of hash rounds selected in the generation of the signature s*. Therefore, the signature verification unit 223 tries the numbers of hash rounds registered in the mapping table 127 in ascending order until the verification succeeds. In the example of FIG. 7, the mapping table 127 indicates one, two, and three as the number of hash rounds. Therefore, the signature verification unit 223 feeds the transaction tx* to the hash function H, and takes the output of the first round of the hash function H as a digest d*₁. The signature verification unit 223 compares the decryption result of the signature s* with the digest d*₁. If they match, the verification is determined to be successful at this point in time.

If they do not match, then the signature verification unit 223 feeds the output of the first round of the hash function H to the hash function H, and takes the output of the second round of the hash function H as a digest d*₂. The signature verification unit 223 compares the decryption result of the signature s* with the digest d*₂. If they match, the verification is determined to be successful at this point in time. If they still do not match, then the signature verification unit 223 feeds the output of the second round of the hash function H to the hash function H, and takes the output of the third round of the hash function H as a digest d*₃. The signature verification unit 223 compares the decryption result of the signature s* with the digest d*₃. If they match, the verification is determined to be successful.

In the manner described above, if the decryption result of the signature s* matches the digest d* with respect to one of the numbers of hash rounds registered in the mapping table 127, the verification as a whole is determined to be successful. If the decryption result of the signature s* does not match the digest d* with respect to any of the numbers of hash rounds registered in the mapping table 127, however, the verification as a whole is determined to fail.

If the final verification result indicates a success, the signature verification unit 223 searches the mapping table 127 for the payment system identifier corresponding to the number of hash rounds that has led to the verification success. The signature verification unit 223 notifies the transaction detection unit 222 of the payment system identifier. The transaction detection unit 222 then requests the payment system identified by the received identifier to perform the payment.

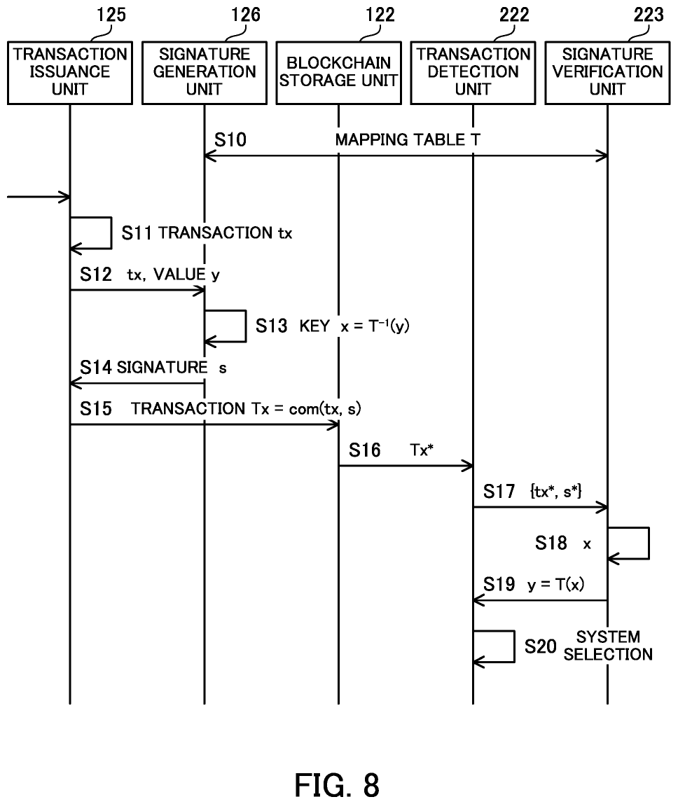

FIG. 8 is a sequence diagram illustrating an example flow of signature generation and signature verification.

The signature generation unit 126 and the signature verification unit 223 share a mapping table T (S10). Each time updating the mapping table T, the signature generation unit 126 may send the updated mapping table T to the signature verification unit 223. Alternatively, the signature generation unit 126 may periodically send the mapping table T to the signature verification unit 223. Similarly, the signature verification unit 223 may update the mapping table T and send it to the signature generation unit 126.

The transaction issuance unit 125 receives input data and the identifier of a payment system from a user. Then, the transaction issuance unit 125 generates a transaction tx from the input data (S11). The transaction issuance unit 125 may output the input data to the SC execution unit 124 to invoke a smart contract.

The transaction issuance unit 125 outputs the transaction tx and a value y that is the payment system identifier to the signature generation unit 126 (S12). The signature generation unit 126 searches the mapping table T for the key x corresponding to the value y (S13). In the second embodiment, the key x indicates the number of hash rounds. The mapping table T may be an associative array that allows both a forward search, which enables a search for the value y from the key x, and a reverse search, which enables a search for the key x from the value y. The signature generation unit 126 generates a signature s from the transaction tx and the key x, and outputs the signature s to the transaction issuance unit 125 (S14).

The transaction issuance unit 125 combines the signature s with the transaction tx to thereby generate a transaction Tx, and then stores the transaction Tx in the blockchain storage unit 122 (S15). The transaction detection unit 222 reads out a newly stored transaction Tx* from the blockchain storage unit 122 (S16).

The transaction detection unit 222 extracts a transaction tx* and a signature s* from the transaction Tx* and outputs them to the signature verification unit 223 (S17). The signature verification unit 223 verifies the signature s* with reference to the mapping table T. In the course of this process, the signature verification unit 223 determines a key x that leads to a verification success (S18). The signature verification unit 223 searches the mapping table T for the value y corresponding to the key x, and outputs the value y to the transaction detection unit 222 (S19). The transaction detection unit 222 selects the payment system indicated by the value y, and sends a payment request message to the selected payment system (S20).

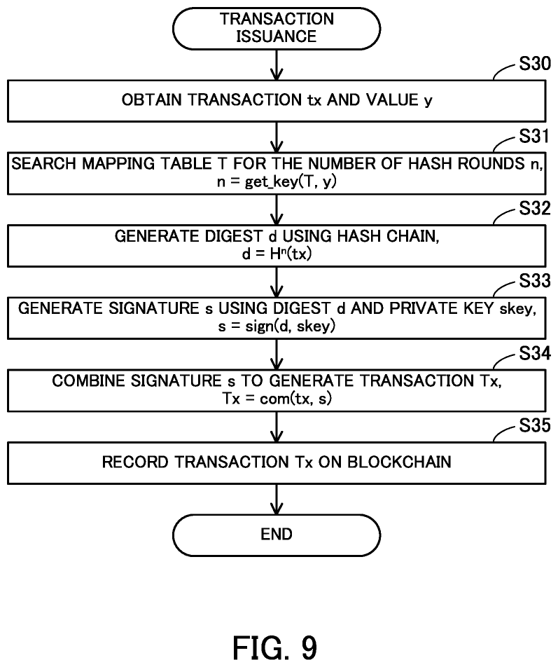

FIG. 9 is a flowchart illustrating a first example of a transaction issuance procedure.

(S30) The signature generation unit 126 obtains a transaction tx and a value y. The value y is the identifier of a designated payment system.

(S31) The signature generation unit 126 searches the mapping table T (mapping table 127) for the number of hash rounds n associated with the value y. For example, the signature generation unit 126 obtains n=get_key(T, y) using a function get_key.

(S32) The signature generation unit 126 generates a digest d from the transaction tx using a hash chain that iteratively uses the hash function H for the number of hash rounds n.

(S33) The signature generation unit 126 generates a signature s using the digest d and the private key skey of the securities system 31. For example, the signature generation unit 126 calculates s=sign(d, skey) using a function sign. The private key skey is stored in the server device 100 so as not to be leaked, for example.

(S34) The transaction issuance unit 125 combines the generated signature s with the transaction tx to thereby generate a transaction Tx.

(S35) The transaction issuance unit 125 records the transaction Tx on a blockchain. For example, the transaction issuance unit 125 adds the transaction Tx to the last block of the blockchain.

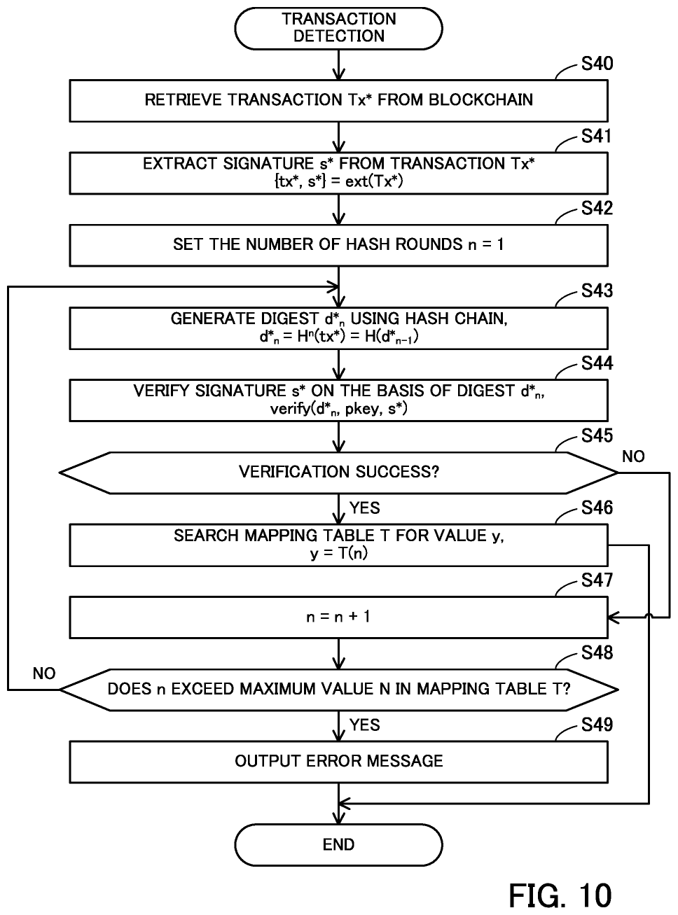

FIG. 10 is a flowchart illustrating a first example of a transaction detection procedure.

(S40) The transaction detection unit 222 retrieves a transaction Tx* from the blockchain. For example, the transaction Tx* is a transaction for which payment has not been made among transactions that have a specific pattern indicating a sales contract for securities.

(S41) The transaction detection unit 222 extracts a transaction tx* and a signature s* from the transaction Tx*.

(S42) The signature verification unit 223 initializes the number of hash rounds n to one.

(S43) The signature verification unit 223 generates a digest d*ₙ from the transaction tx* using a hash chain that performs the hash operation n times. Note that if n is a value of two or greater, the digest d*ₙ₋₁ has already been generated. In this case, the signature verification unit 223 feeds the digest d*ₙ₋₁ to the hash function H.

(S44) The signature verification unit 223 feeds the digest d*ₙ, the public key pkey of the securities system 31, and the signature s* to a verification function to verify the signature s*. The verification function outputs a flag indicating a verification success or failure. For example, the verification function decrypts the signature s* with the public key pkey and checks if the decryption result matches the digest d*ₙ.

(S45) The signature verification unit 223 determines whether the output of the verification function indicates a verification success. If the output indicates a verification success, the process proceeds to step S46. If the output indicates a verification failure, the process proceeds to step S47.

(S46) The signature verification unit 223 searches the mapping table T (mapping table 127) for the value y corresponding to the number of hash rounds n. The transaction detection unit 222 selects the payment system indicated by the value y. The transaction detection process is now completed.

(S47) The signature verification unit 223 updates n to n+1.

(S48) The signature verification unit 223 determines whether the number of hash rounds n exceeds a value N indicating the maximum number of hash rounds in the mapping table T. If n exceeds N, the process proceeds to step S49. If n is less than or equal to N, the process returns to step S43.

(S49) The signature verification unit 223 outputs an error message indicating a verification failure for the signature s*. The transaction detection unit 222 or the signature verification unit 223 may save the error message in a log file. In addition, the transaction detection unit 222 may send the error message to the transaction issuance unit 125.

The following supplements the description on the consistency between signatures with and without communication of the number of hash rounds n. Without communication of the number of hash rounds n, the digest d is expressed as d=H(tx) using the hash function H and the transaction tx. Furthermore, the signature s is expressed as s=sign(d, skey) using the signature function sign, the digest d, and the private key skey. Therefore, the signature s is expressed as s=sign(H(tx), skey)=f(tx, skey).

On the other hand, with communication of the number of hash rounds n, the signature s is expressed as s=sign(Hⁿ(tx), skey)=f(Hⁿ⁻¹(tx), skey). Therefore, the generation of a signature without communication of the number of hash rounds n and the generation of a signature with communication of the number of hash rounds n are compatible with each other in that they match if the transaction tx is replaced with the hash value Hⁿ⁻¹(tx). In addition, the digest d is dependent on the number of hash rounds n, and the signature generation method is not affected by the number of hash rounds n.

As described above, the information processing system of the second embodiment records transactions on a blockchain. This facilitates later proof of the authenticity of the transactions and enhances the reliability of the transactions. In addition, the blockchain application detects a transaction satisfying specified conditions from the blockchain and invokes an external system. Thus, it becomes possible to automatically execute various information processing tasks using reliable transactions recorded on the blockchain.

Furthermore, the identifier of the external system for collaboration is communicated using the signature included in the transaction. Even in the case where the transaction does not include an item to specify the external system, it is possible to implement the above-described blockchain application. That is, the addition of a new blockchain application or the addition of an external system for collaboration does not involve changing the transaction format or changing a smart contract. As a result, the consistency in the blockchain is maintained, and the resetting of the number of transactions, which is used as an indicator for the reliability of the smart contract, is prevented.

Furthermore, the addition of an external system for collaboration may be achieved by adding a record to the mapping table. In this regard, the information processing system exhibits high flexibility. Additionally, modifying a signature so as to communicate the identifier of an external system has little impact on the signature generation algorithm and signature verification algorithm, which enables maintaining the compatibility with existing signatures.

### Third Embodiment

A third embodiment will now be described. The features different from those of the second embodiment will mainly be described, and the description on the same features as those of the second embodiment may be omitted.

The information processing system of the second embodiment and the information processing system of the third embodiment differ in how to reflect the identifier of a payment system on a signature. The information processing system of the third embodiment has the same hardware configuration and the same software structure as illustrated in FIGS. 2 to 4. The following describes the third embodiment with the same reference numerals as used in FIGS. 2 to 4.

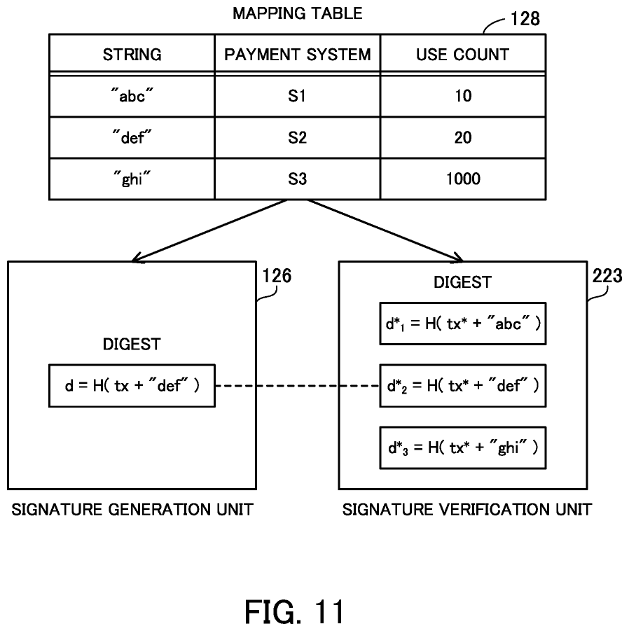

FIG. 11 illustrates an example of signature generation using string concatenation.

In the third embodiment, the mapping table storage units 123 and 221 store a mapping table 128. The mapping table 128 associates a string, a payment system, and a use count with each other. The string is a key, and the payment system is a value. The mapping between strings and payment systems is a bijection, i.e., a one-to-one correspondence. For example, a string “abc” corresponds to a payment system identifier S1, a string “def” corresponds to a payment system identifier S2, and a string “ghi” corresponds to a payment system identifier S3.

The use count of a certain string indicates the number of times the string has been selected for signature generation. The signature generation unit 126 may count the use count for each string and record it in the mapping table 128. In this case, with periodic or irregular synchronization of the mapping table 128, the signature generation unit 126 notifies the signature verification unit 223 of the use counts. Instead of using the use counts themselves, the signature generation unit 126 may notify the signature verification unit 223 of order information indicating the order of the plurality of strings sorted in descending order of use count. Furthermore, the signature verification unit 223 may count the number of times a verification has succeeded for each string and record it in the mapping table 128.

The signature generation unit 126 searches the mapping table 128 for the string corresponding to a received payment system identifier. The signature generation unit 126 adds the found string to a transaction tx without a signature to thereby generate a message. For example, the signature generation unit 126 appends the string to the end of the transaction tx. The signature generation unit 126 feeds the message to the hash function H to generate a digest d. Using the digest d and the private key skey, the signature generation unit 126 generates a signature s.

The signature verification unit 223 generates a digest d* from a transaction tx* in the same manner as the signature generation unit 126. In addition, the signature verification unit 223 decrypts a signature s* with the public key pkey. The signature verification unit 223 compares the decryption result with the digest d*. In this connection, the signature verification unit 223 does not know the correct string selected in the generation of the signature s*. Therefore, the signature verification unit 223 sequentially tries the plurality of strings registered in the mapping table 128 until the verification succeeds. In this process, it is preferable that the signature verification unit 223 sort the plurality of strings in descending order of use count and preferentially try a string with a higher use count.

In the example illustrated in FIG. 11, three strings, “ghi,” “def,” and “abc” are registered in descending order of use count in the mapping table 128. Therefore, the signature verification unit 223 adds the string “ghi” to the transaction tx* and feeds the resultant to the hash function H to thereby generate a digest d*₃. The signature verification unit 223 compares the decryption result of the signature s* with the digest d*₃. If they match, the verification is determined to be successful at this point in time.

If they do not match, then the signature verification unit 223 adds the string “def” to the transaction tx* and feeds the resultant to the hash function H to thereby generate a digest d*₂. The signature verification unit 223 compares the decryption result of the signature s* with the digest d*₂. If they match, the verification is determined to be successful at this point in time. If they do not match, then the signature verification unit 223 adds the string “abc” to the transaction tx* and feeds the resultant to the hash function H to thereby generate a digest d*₁. The signature verification unit 223 compares the decryption result of the signature s* with the digest d*₁. If they match, the verification is determined to be successful at this point in time.

In the manner described above, if the decryption result of the signature s* matches the digest d* with respect to one of the strings registered in the mapping table 128, the verification as a whole is determined to be successful. On the other hand, if the decryption result of the signature s* does not match the digest d* with respect to any of the strings registered in the mapping table 128, the verification as a whole is determined to fail. If the final verification result indicates a success, the signature verification unit 223 searches the mapping table 128 for the payment system identifier corresponding to the string that has led to the verification success, and notifies the transaction detection unit 222 of the found payment system identifier.

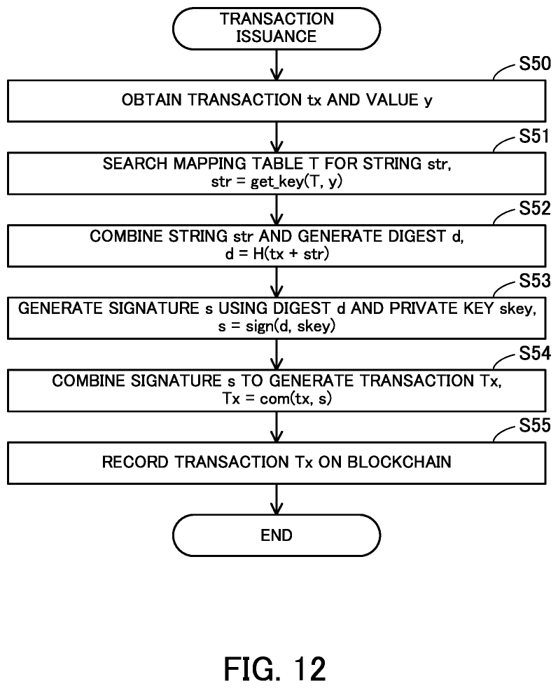

FIG. 12 is a flowchart illustrating a second example of the transaction issuance procedure.

(S50) The signature generation unit 126 obtains a transaction tx and a value y. The value y is the identifier of a designated payment system.

(S51) The signature generation unit 126 searches the mapping table T (mapping table 128) for the string str associated with the value y. For example, the signature generation unit 126 obtains str=get_key(T, y) using the function get_key.

(S52) The signature generation unit 126 combines the string str with the transaction tx and feeds the resultant to the hash function H to thereby generate a digest d.

(S53) The signature generation unit 126 generates a signature s using the digest d and the private key skey of the securities system 31. For example, the signature generation unit 126 calculates s=sign(d, skey) using the function sign.

(S54) The transaction issuance unit 125 combines the generated signature s with the transaction tx to thereby generate a transaction Tx.

(S55) The transaction issuance unit 125 records the transaction Tx on the blockchain. For example, the transaction issuance unit 125 adds the transaction Tx to the last block of the blockchain.

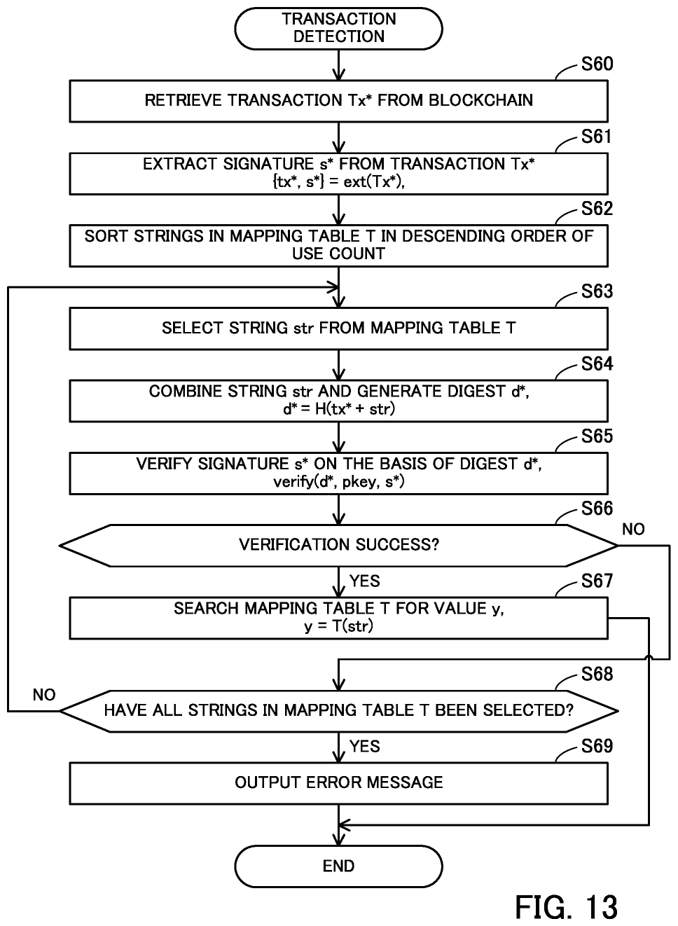

FIG. 13 is a flowchart illustrating a second example of the transaction detection procedure.

(S60) The transaction detection unit 222 retrieves a transaction Tx* from the blockchain. The transaction Tx* is a transaction for which payment has not been made among transactions that have a specific pattern indicating a sales contract for securities, for example.

(S61) The transaction detection unit 222 extracts a transaction tx* and a signature s* from the transaction Tx*.

(S62) The signature verification unit 223 sorts the plurality of strings registered in the mapping table T (mapping table 128) in descending order of use count.

(S63) The signature verification unit 223 selects a string str from the mapping table T. Here, the signature verification unit 223 preferentially selects one string that has not been selected yet and has a higher use count.

(S64) The signature verification unit 223 combines the string str with the transaction tx* and feeds the resultant to the hash function H to thereby generate a digest d*.

(S65) The signature verification unit 223 feeds the digest d*, the public key pkey of the securities system 31, and the signature s* to the verification function to verify the signature s*. The verification function outputs a flag indicating a verification success or failure. For example, the verification function decrypts the signature s* with the public key pkey and checks if the decryption result matches the digest d*.

(S66) The signature verification unit 223 determines whether the output of the verification function indicates a verification success. If the output indicates a verification success, the process proceeds to step S67. If the output indicates a verification failure, the process proceeds to step S68.

(S67) The signature verification unit 223 searches the mapping table T for the value y corresponding to the selected string str. The transaction detection unit 222 selects the payment system indicated by the value y. The transaction detection is now completed.

(S68) The signature verification unit 223 determines whether all the strings registered in the mapping table T have been selected, i.e., whether the string with the least use count has been selected. If all the strings in the mapping table T have been selected, the process proceeds to step S69. If there is at least one string remaining unselected in the mapping table T, the process returns to step S63.

(S69) The signature verification unit 223 outputs an error message indicating that the verification of the signature s* has failed. The transaction detection unit 222 or the signature verification unit 223 may save the error message in a log file. In addition, the transaction detection unit 222 may send the error message to the transaction issuance unit 125.

The following supplements the description on the consistency between signatures with and without communication of the string str. As described earlier in the second embodiment, without communication of the string str, the signature s is expressed as s=sign(H(tx), skey)=f(tx, skey). On the other hand, with communication of the string str, the signature s is expressed as s=sign(H(tx+str), skey)=f(tx+str, skey).

Therefore, the generation of a signature without communication of the string str and the generation of a signature with communication of the string str are compatible with each other in that they match if the transaction tx is replaced with the message tx+str. By contrast, for example, if the digest d is defined as d=H(tx)+str, the algorithm compatibility is not maintained. In addition, the digest d is dependent on the string str, and the signature generation method is not affected by the string str. As described above, the information processing system of the third embodiment provides the same effects as that of the second embodiment.

According to one aspect, it is possible to prevent inconsistency in a blockchain.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A notification control method comprising:
calculating, by a processor, upon receiving identification information identifying a processing system for processing transaction data to be recorded on a blockchain among a plurality of processing systems, a function value using a parameter corresponding to the received identification information and a function; and
notifying, by the processor, a determination unit of the transaction data and signature data generated from the function value, the determination unit being configured to determine the processing system for processing the transaction data from among the plurality of processing systems.

2. The notification control method according to claim 1, wherein:
the parameter indicates a number of transformation rounds associated with the received identification information; and
the calculating of the function value includes performing iterative data transformation using the function on the transaction data, according to the number of transformation rounds indicated by the parameter.

3. The notification control method according to claim 2, wherein, in response to the number of transformation rounds being two or greater, the performing of the iterative data transformation includes feeding the transaction data to the function to calculate an intermediate function value, and feeding the intermediate function value to the function.

4. The notification control method according to claim 1, wherein the calculating of the function value includes calculating the function value by generating input data from the transaction data and the parameter and feeding the input data to the function.

5. The notification control method according to claim 4, wherein:
the parameter indicates a string associated with the received identification information; and
the generating of the input data includes adding the string to the transaction data.

6. The notification control method according to claim 1, wherein:
the function is a hash function;
the function value is a hash value calculated from the transaction data according to the parameter; and
the signature data is generated using the hash value and a private key.

7. A verification method comprising:
calculating, by a processor, upon receiving transaction data and signature data that are to be recorded on a blockchain, a function value using a parameter corresponding to identification information identifying one of a plurality of processing systems and a function;
verifying, by the processor, the signature data using the function value; and
determining, by the processor, a processing system for processing the transaction data from among the plurality of processing systems, based on whether the verifying of the signature data is successful or not.

8. The verification method according to claim 7, wherein the calculating of the function value includes
monitoring a frequency of use of each of the plurality of processing systems, and
selecting identification information of a processing system with a highest frequency of use.

9. An information processing apparatus comprising:
a memory that stores transaction data to be recorded on a blockchain; and
a processor coupled to the memory and the processor configured to:
calculate, upon receiving identification information identifying a processing system for processing the transaction data among a plurality of processing systems, a function value using a parameter corresponding to the received identification information and a function; and
notify a determination unit of the transaction data and signature data generated from the function value, the determination unit being configured to determine the processing system for processing the transaction data from among the plurality of processing systems.
